(19) United States
(12) Patent Application Publication
(10) Pub. No.: US 2026/0226969 A1
(43) Pub. Date: Aug. 6, 2026

(54) GEARWHEEL, DEVICE AND WORK MACHINE

(71) Applicant: DEERE & COMPANY, MOLINE, IL (US)

(72) Inventors: TOBIAS STEINER, Hainfeld (DE); MARTIN CEBULLA, Rottstrasse (DE)

(21) Appl. No.: 19/396,419

(22) Filed: Nov. 21, 2025

(30) Foreign Application Priority Data
Feb. 4, 2025 (EP) 25155702.1

(51) Int. Cl. F16H 48/08; F16H 55/08

(52) U.S. Cl. CPC F16H 48/08; F16H 55/08

(57) ABSTRACT

A gearwheel includes a gearwheel side and a rear side opposite the gearwheel side, the rear side of the gearwheel including a microstructure having a depth between 100 μm and 0.1 μm inclusive.

### CROSS-REFERENCE TO RELATED APPLICATIONS

This application claims priority to European Patent Application No. 25155702.1, filed Feb. 4, 2025, which is hereby incorporated by reference.

### FIELD OF THE DISCLOSURE

The disclosure relates to a gearwheel, to a device including a gearwheel, and to a work machine having a device with a gearwheel.

### BACKGROUND

Gearwheels serve to transmit rotational movements and torques (power transmission) from a drive shaft to an output shaft, wherein they may be in the form of spur gears, bevel gears, hypoid gears, crown gears, helical gears, or worm gears.

### SUMMARY

According to an aspect of the present disclosure, a gearwheel includes a gearwheel side and a rear side opposite the gearwheel side, the rear side including a microstructure having a depth between 100 μm and 0.1 μm inclusive.

According to an aspect of the present disclosure, the gearwheel includes a bevel gear.

According to an aspect of the present disclosure, the gearwheel includes a crown gear.

According to an aspect of the present disclosure, the microstructure includes a depth less than or equal to 50 μm and greater than or equal to 1 μm.

According to an aspect of the present disclosure, the microstructure includes a depth of less than or equal to 20 μm and greater than or equal to 5 μm.

According to an aspect of the present disclosure, the microstructure includes a depth of less than or equal to 10 μm and greater than or equal to 5 μm.

According to an aspect of the present disclosure, the rear side includes one or more bores.

According to an aspect of the present disclosure, the microstructure is arranged at a radius of less than or equal to 50 mm around each recess.

According to an aspect of the present disclosure, the microstructure is arranged at a radius of less than or equal to 30 mm around each recess.

According to an aspect of the present disclosure, the microstructure is arranged at a radius of less than or equal to 20 mm around each recess.

According to an aspect of the present disclosure, a device includes a gearwheel having a gearwheel side and a rear side opposite the gearwheel side, the rear side including a microstructure and one or more bores, and a component including one or more further bores.

According to an aspect of the present disclosure, the one or more bores and the one or more further bores are arranged in coaxial arrangement when the component and the gearwheel are connected together.

According to an aspect of the present disclosure, the gearwheel and the component are connectable together for conjoint rotation by fastening means arranged in the one or more bores and one or more further bores.

According to an aspect of the present disclosure, the device includes a flange, the component is arranged between the flange and the gearwheel, and the flange includes one or more additional bores.

According to an aspect of the present disclosure, the one or more bores, the one or more further bores, and the one or more additional bores. are arranged in a coaxial manner when the component and the gearwheel and the flange are connected together.

According to an aspect of the present disclosure, the gearwheel and the component and the flange are connectable together for conjoint rotation by fastening means arranged in the one or more bores, one or more further bores, and one or more additional bores.

According to an aspect of the present disclosure, the component includes a differential housing.

According to an aspect of the present disclosure, a work machine includes the device of one or more embodiments disclosed herein.

The above and other features will become apparent from the following detailed description and accompanying drawings.

### BRIEF DESCRIPTION OF THE DRAWINGS

The disclosure and further advantages and advantageous developments and configurations of the disclosure, both in terms of the hardware and of the method, will be explained in more detail below by means of example embodiments and with reference to the drawings. Components with an equivalent or comparable function are identified here by the same reference signs. In the drawings:

FIG. 1 shows a schematic illustration of a first example embodiment of a work machine according to the disclosure;

FIG. 2 shows a schematic illustration of the first example embodiment of the gearwheel according to the disclosure;

FIG. 3 shows a schematic illustration of the rear side of the gearwheel according to the disclosure from FIG. 2; and

FIG. 4 shows a schematic illustration of a first example embodiment of the device according to the disclosure.

Like reference numerals are used to indicate like elements throughout the several figures.

### DETAILED DESCRIPTION

The embodiments or implementations disclosed in the above drawings and the following detailed description are not intended to be exhaustive or to limit the present disclosure to these embodiments or implementations.

A specific design of bevel gears or crown gears, for example with hypoid gearings, is used in automotive engineering, generally in the case of axle drives. During the power transmission from the gearwheel, for example a bevel gear, to the differential, for example a differential housing, the torque at the gearwheel, for example at the bevel gear or crown gear, is introduced into the differential housing via a screw connection, for example a screw flange connection. In this case, the power transmission takes place by means of a frictional connection via a rear side of the gearwheel. The preload force required for the frictional connection is applied by a plurality of screws distributed around the circumference.

The gearwheel may have a coating which has a significant influence on the coefficient of friction. The latter is considerably reduced by the coating. If the frictional assembly is intended to transmit the same torque as with an uncoated bevel gear, this has previously been possible only by increasing the preload force.

Proceeding from the prior art, the present disclosure addresses the problem of proposing a gearwheel, a device and a work machine that are improved compared with the prior art. Specifically, the present disclosure may address the problem of proposing a gearwheel and/or a device and/or a work machine that are designed with a simpler structure and/or have improved efficiency during power transmission, for example to transmit a higher torque, and/or have a higher coefficient of friction.

This problem is solved by a gearwheel having the features of one or more embodiments disclosed herein, and a device having the features of one or more embodiments disclosed herein, and a work machine having the features of one or more embodiments disclosed herein. Some of the embodiments relate to particularly advantageous embodiments of the disclosure.

In the following text, the term “connected” can be understood as meaning for example mechanically connected and/or mechanically operatively connected. For example, the term “connected” can be understood, additionally or alternatively, as meaning drivably connected, i.e., connected for torque transmission and/or speed transmission, and/or coupled, i.e., for example, mechanically coupled and/or rigidly coupled, and/or coupled for conjoint rotation. The term “connectable” can be understood as meaning for example mechanically connectable and/or mechanically operatively connectable. For example, the term “connectable” can be understood, additionally or alternatively, as meaning drivably connectable, i.e., connectable for torque transmission and/or speed transmission, and/or couplable, i.e., mechanically couplable and/or rigidly couplable, and/or connectable for conjoint rotation. For example, the term “connected” can therefore be understood as meaning a connection of two components which makes it possible to transmit energy and/or a force and/or a torque and/or a speed from one component to the other component, for example mechanically. Further components or parts that allow such a transmission of energy and/or force and/or torque and/or transmission of a speed between the two components can be provided between the two components.

The disclosure proposes a gearwheel. The gearwheel comprises a gearwheel side and a rear side opposite and/or facing away from the gearwheel side. The rear side of the gearwheel has a microstructure. The gearwheel may also have an encircling circumferential side. The gearwheel may also have an encircling inner circumferential side. The gearwheel may be substantially cylindrical and/or a cylinder and/or in the form of a disc. In this case, the gearwheel side may be a first base, and the rear side may be a second base of the cylinder. The encircling circumferential side may be the lateral surface of the gearwheel, for example of the cylindrical gearwheel. The gearwheel may also be substantially in the form of a hollow cylinder, however. In this case, the gearwheel side may be a first base with a wall thickness, and the rear side may be a second base with the same wall thickness of the hollow cylinder. The encircling circumferential side may be the lateral surface of the hollow cylinder. The encircling inner circumferential side may be a further lateral surface of the hollow cylinder. The gearwheel side and the base side may be substantially parallel.

Furthermore, teeth for power transmission may be arranged on the gearwheel side. With the teeth or by way of the teeth, power, i.e., for example, energy and/or a force and/or a torque and/or a speed, can be transmitted, for example transmitted mechanically, from the gearwheel or to the gearwheel.

According to the disclosure, a microstructure should be understood as being a depression and/or an elevation on or in the rear side, for example a depression and/or an elevation on or in a surface and/or coating of the rear side of the gearwheel. For example, such a microstructure can be in the form of a depression and/or an elevation in the material, i.e., for example, the surface and/or coating of the rear side. Furthermore, the microstructure can be formed by a material elevation and/or material depression. For example, this microstructure is arranged on the entire rear side. Also, for example, the microstructure can extend, at least in some sections or for example entirely, along a structuring line. The structuring line may be understood, for example, as being a geometric, simple description of the longitudinal extent of the microstructure. For example, the structuring line may be an average course of the microstructure. Furthermore, a cross-sectional profile of the microstructure may describe, for example, the shape of the depression and/or elevation. Moreover, the structuring line can describe the location and the course of the microstructure on the rear side of the gearwheel at least approximately. The gearwheel may have one or more microstructures on the rear side. The microstructure or microstructures may be distributed on the surface of the rear side or comprise the entire surface of the rear side.

The microstructure may be applied to the rear side by means of material erosion; for example, the material erosion may be applied by means of a laser structuring process. Similarly, the microstructure can be produced on the gearwheel by a 3D printing process. This allows particularly rapid and precise application of the at least one microstructure to the rear side of the gear wheel.

It is important to the disclosure for the rear side of the gearwheel to have the microstructure. Advantageously, compared with a conventional gearwheel, such a gearwheel has improved efficiency in terms of power transmission. For example, the gearwheel has a higher coefficient of friction on the rear side. Furthermore, a higher torque can advantageously be transmitted with the gearwheel.

In some embodiments of the disclosure, the gearwheel is in the form of a bevel gear and/or crown gear. For example, the gearwheel may be in the form of a bevel gear and/or crown gear with octoid or involute toothing. Such a gearwheel has, in the embodiment according to the disclosure, a particularly high efficiency.

In some embodiments of the disclosure, the microstructure has, at least in some sections, a depth (t) of less than or equal to 100 μm, for example 50 μm, particularly for example 20 μm, in particular 10 μm, for example with regard to the surface of the rear side and/or the surface of the coating of the rear side, in particular without a microstructure. The microstructure has, at least in some sections, a depth (t) of at least greater than or equal to 0.1 μm, for example 1 μm, particularly for example 5 μm, for example with regard to the surface of the rear side and/or the surface of the coating of the rear side, in particular without a microstructure. Furthermore, alternative or additionally, the microstructure may have, at least in some sections, a height (h) of less than or equal to 100 μm, for example 50 μm, particularly for example 20 μm, in particular 10 μm, for example with regard to the surface of the rear side and/or the surface of the coating of the rear side, in particular without a microstructure. The microstructure may have, at least in some sections, a height (h) of at least greater than or equal to 0.1 μm, for example 1 μm, particularly for example 5 μm, for example with regard to the surface of the rear side and/or the surface of the coating of the rear side, in particular without a microstructure. In particular, the microstructure or a multiplicity of the microstructures and particularly for example all of the microstructures may have the abovementioned depth and/or height. In particular, by choosing the depth and/or height of the microstructure from the abovementioned range, particularly good efficiency of the gearwheel during power transmission is achievable.

In some embodiments of the disclosure, the rear side of the gearwheel has one or more recesses, for example one or more bores. The recess or recesses, for example one or more bores, may have screw threads. The recesses, for example the bores, may be distributed symmetrically on the rear side, for example radially. The recesses, for example the bores, may have the same radius or be at the same distance from an axis of rotation of the gearwheel. For example, the gearwheel may comprise at least 2, for example more than or equal to 5, particularly for example more than or equal to 10 recesses, for example bores.

In some embodiments of the disclosure, a microstructure is arranged at a radius of less than or equal to 50 mm, for example 30 mm, particularly for example 20 mm, around each recess, for example bore. The radius may in this case be in relation to a center line or perpendicular bisector of the particular recess or bore, for example the openings thereof. For example, each microstructure can be understood as being a depression and/or elevation which extends, for example radially, around the recess or bore on the rear side of the gearwheel. For example, as a result of the use of a laser beam, the surface can be melted in a targeted manner such that a reproducibly arranged microgeometry is produced. The microgeometry has a raised pattern that is arranged transversely to the circumferential force and is located within or in the immediate vicinity of the screw deformation cone.

The disclosure also relates to a device. The device comprises a gearwheel, for example according to any of the embodiments disclosed herein, and a component.

In some embodiments of the disclosure, the component has one or more further recesses, for example one or more further bores. The recesses and the further recesses, for example one or more further bores, may be arranged in an aligned and/or coaxial and/or axially parallel and/or overlapping manner, for example when the component and the gearwheel are connected together. For example, the center line or perpendicular bisector of each recess or bore, for example the openings thereof, may be coaxial or axially parallel.

In some embodiments of the disclosure, the gearwheel and the component are connected or connectable together, for example connected or connectable together for conjoint rotation. The gearwheel and the component may be connected or connectable together, for example in a cooperative manner, for example be connected or connectable together for conjoint rotation and/or be secured together, by way of fastening means arranged in the recesses and further recesses.

The fastening means may be, for example, screws. The fastening means may be arranged in the recesses, for example bores. For example, the fastening means may be passed through the recesses, for example bores. The fastening means may be secured in the recesses by the screw threads.

The introduction of the preload force by tightening the fastening means brings about a micro form-fit between the gearwheel and the component, for example a differential housing, in the region of the microstructure. This form-fit may be considered to be an optimized or enhanced coefficient of friction. As a result, it is possible to dispense, for example, with removing the coating on the rear side of the gearwheel, for example of the bevel gear or crown gear. It is also possible, as a result of the higher coefficient of friction, to reduce the size and/or the number of the fastening means with a given torque, or, in an existing design, to be able to transmit a higher torque with the same number of fastening means.

In some embodiments of the disclosure, the device comprises a flange, and the component is arranged between the flange and the gearwheel. The flange may have one or more further recesses, for example one or more further bores. The recesses and the further recesses in the component and the further recesses in the flange may be arranged in an aligned and/or coaxial and/or axially parallel and/or overlapping manner, for example when the component and the gearwheel and the flange are connected together.

In some embodiments of the disclosure, the gearwheel and the component and the flange are connected or connectable together in a cooperative manner, for example connected or connectable together for conjoint rotation and/or secured together, by way of the fastening means arranged in the recesses and further recesses.

In some embodiments of the disclosure, the component is a differential housing.

The disclosure also relates to a work machine having a device, for example a device according to any of the embodiments disclosed herein. The work machine may be a construction machine or a towing vehicle, for example an agricultural towing vehicle, for example a tractor. The work machine has the above-described advantages.

The work machine may be drivable with a speed and/or force and/or a torque of a motor. The work machine may comprise the one or more ground-engaging means. The ground-engaging means can support and/or carry the work machine on the ground. The ground-engaging means can be wheels or tracks or chains. For example, the ground-engaging means can be front wheels and rear wheels.

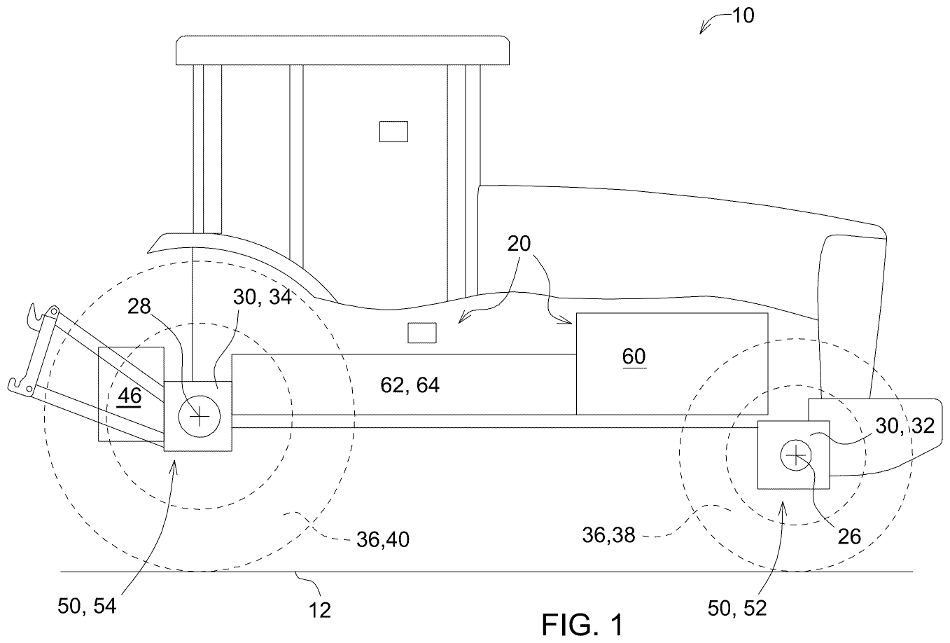

FIG. 1 shows a schematic illustration of a first example embodiment of a work machine 10 according to the disclosure, in this case an agricultural towing vehicle or tractor, for example having a device 30 according to the disclosure. The work machine 10 comprises a drive device 20. Moreover, the work machine 10 is drivable by the drive device 20.

The work machine 10, for example the drive device 20, comprises a first vehicle axle 26 and a second vehicle axle 28. The first vehicle axle 26 may be a front axle and the second vehicle axle 28 a rear axle. Moreover, the first vehicle axle 26 may be embodied as a steerable axle. The work machine 10, for example the drive device 20, may comprise a traction drive 50, for example a front-axle drive 52 and a rear-axle drive 54. The work machine 10 may have one or more ground-engaging means 36, in this case illustrated in the form of wheels 38, 40, which engage with an underlying surface 12 in order to transmit drive forces and/or by way of which the work machine 10 is supported on the underlying surface 12. Alternatively, the ground-engaging means 36 may also be in the form of and arranged as tracks or chains.

The traction drive 50 may comprise the first vehicle axle 26 and/or the second vehicle axle 28 and/or a device 30 according to the disclosure and/or a first differential 32 and/or a second differential 34 and/or the one or more ground-engaging means 36. The first vehicle axle 26 may be connected to the first differential 30. The second vehicle axle 28 may be connected to the second differential 32.

The work machine 10, for example the drive device 20, comprises a motor 50 and a drive train 52, for example a transmission 54. With the drive device 20, for example the motor 50, a rotational movement and/or a force and/or a torque and/or a speed can be able to be generated and can be transmissible to the first and/or second vehicle axle 26, 28, for example via the drive train 52, for example the transmission 54, and the device 30. The first and/or second vehicle axle 26, 28 convert the rotational movement and/or the force and/or the torque and/or the speed into a rotational movement and/or force and/or torque and/or speed of one or more ground-engaging means 36, and thus into propulsion of the work machine 10.

The work machine 10, for example the drive device 20, may comprise a first power output 46. The first power output may comprise a PTO unit 222. The first power output 46 may be provided to drive an implement (not shown) which is attachable to the work machine 10 via an interface (for example a three-point interface).

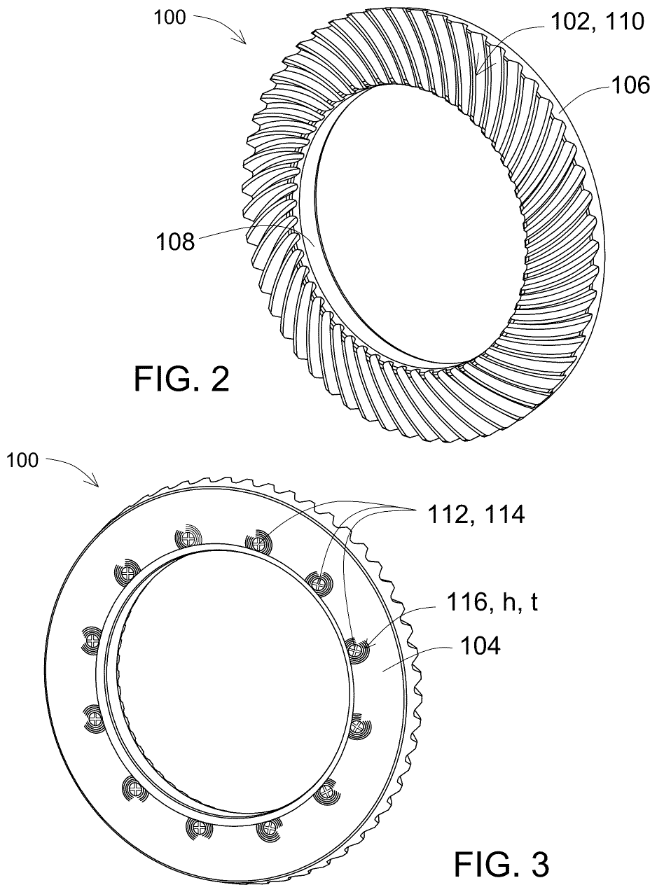

FIG. 2 shows a schematic illustration of a first example embodiment of the gearwheel 100 according to the disclosure. The work machine 10 illustrated in FIG. 1 may comprise the gearwheel 100 illustrated in FIG. 2.

The gearwheel 100 comprises a gearwheel side 102 and a rear side 104 opposite and/or facing away from the gearwheel side 102. The gearwheel 100 furthermore comprises an encircling circumferential side 106. Likewise, the gearwheel 100 may have an encircling inner circumferential side 108. The rear side 104 of the gearwheel 100 has a microstructure 116 (see FIG. 3).

Teeth 110 are arranged on the gearwheel side 102. The teeth 110 are designed for power transmission from or to a further gearwheel, for example a pinion. In the present case, the gearwheel 100 is in the form of a bevel gear or crown gear, for example of a bevel gear and/or crown gear with octoid or involute toothing.

FIG. 3 shows a schematic illustration of the rear side 104 of the gearwheel 100 according to the disclosure from FIG. 2. The work machine 10 illustrated in FIG. 1 may comprise the gearwheel 100 illustrated in FIG. 3.

The gearwheel 100, for example the rear side 104, has a plurality of recesses 112, for example bores 114. In the present case, for example 12 recesses 112, for example bores 114. Not all of the recesses 112, for example bores 114, are provided with reference signs.

Furthermore, microstructures 116 are arranged in a region around each recess 112, for example bore 114. The microstructure 116 extends substantially around the recesses 112. For clarity, the microstructure 116 is schematically illustrated. The depression and/or elevation of the microstructure 116 may extend radially around each recess 112. The microstructure 116 may be arranged at a radius of less than or equal to 50 mm, for example 30 mm, particularly for example 20 mm, around each recess 112. Not all of the microstructures 116 are provided with reference signs.

Furthermore, the microstructure 116 may have, at least in some sections, a depth t of less than or equal to 100 μm, for example 50 μm, particularly for example 20 μm, for example 10 μm, and/or the microstructure 116 may have, at least in some sections, a depth t of at least greater than or equal to 0.1 μm, for example 1 μm, particularly for example 5 μm. Likewise, the microstructure 116 may have, at least in some sections, a height h of less than or equal to 100 μm, for example 50 μm, particularly for example 20 μm, for example 10 μm, and/or the microstructure may have, at least in some sections, a height h of at least greater than or equal to 0.1 μm, for example 1 μm, particularly for example 5 μm. The depth and/or height of the microstructure 116 is in this case, in relation to the remaining geometry of the rear side, schematically illustrated, this serving for better presentability.

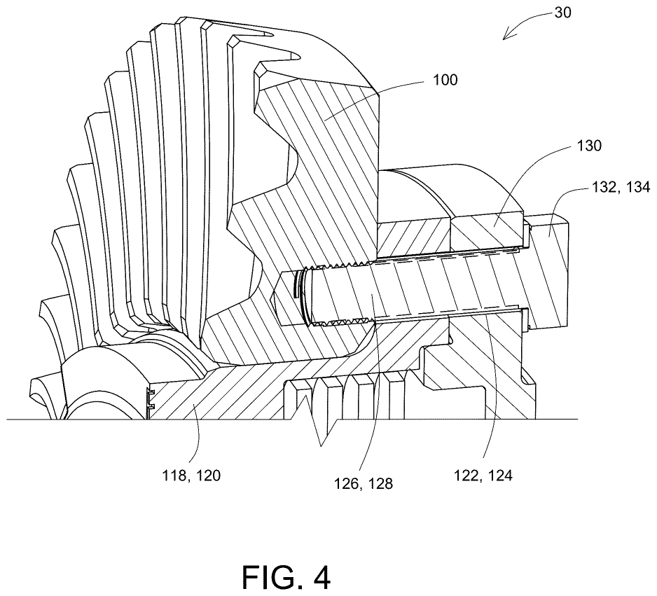

FIG. 4 shows a schematic illustration of a first example embodiment of the device 30 according to the disclosure. The device 30 shown in FIG. 4 corresponds substantially to the device 30 shown in FIG. 1, and so only details and/or differences are discussed in the following text. The device 30 shown in FIG. 4 may comprise the gearwheel 100 shown in FIGS. 2 and 3, and so only details and/or differences are discussed in the following text. The work machine 10 illustrated in FIG. 1 may comprise the device 30 illustrated in FIG. 4.

The device comprises the gearwheel 100 and a component 118. The component 118 may be a differential housing 120. The component 118, for example the differential housing 120, may have one or more further recesses 122, for example one or more further bores 124.

The recesses 112, for example the bores 114, and the further recesses 122, for example the further bores 124, may be arranged in an aligned and/or coaxial and/or axially parallel and/or overlapping manner, for example when the component 118 and the gearwheel 100 are connected together.

The gearwheel 100 and the component 118 are connected together, for example connected together for conjoint rotation. The gearwheel 100 and the component 118 are connected together in a cooperative manner, for example connected together for conjoint rotation and/or secured together, by way of a fastening means 126, in the present case a screw 128, arranged in the recess 112, for example the bore 114, and the further recess 122, for example the further bore 124.

Furthermore, the device 30 may comprise a flange 130. The component 118 is arranged between the flange 130 and the gearwheel 100. The flange 130 has one or more further recesses 132, for example one or more further bores 134.

The recesses 112, for example the bores 114, and the further recesses 122, for example further bores 124, in the component 118 and the further recesses 132, for example the further bores 134, in the flange 130 are arranged in an aligned and/or coaxial and/or axially parallel and/or overlapping manner, for example when the component 118 and the gearwheel 100 and the flange 130 are connected together.

The gearwheel 100 and the component 118 and the flange 130 are connected together in a cooperative manner, for example connected together for conjoint rotation and/or secured together, by way of the fastening means 126, in the present case the screw 128, arranged in the recess 112, for example bore 114, and in the further recesses 122, 132, for example the further bores 124, 134.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A gearwheel, comprising:
a gearwheel side and a rear side opposite the gearwheel side, the rear side including a microstructure having a depth between 100 μm and 0.1 μm inclusive.

2. The gearwheel of claim 1, wherein the gearwheel comprises a bevel gear.

3. The gearwheel of claim 1, wherein the gearwheel comprises a crown gear.

4. The gearwheel of claim 1, wherein the microstructure includes a depth less than or equal to 50 μm and greater than or equal to 1 μm.

5. The gearwheel of claim 1, wherein the microstructure includes a depth of less than or equal to 20 μm and greater than or equal to 5 μm.

6. The gearwheel of claim 1, wherein the microstructure includes a depth of less than or equal to 10 μm and greater than or equal to 5 μm.

7. The gearwheel of claim 1, wherein the rear side includes one or more bores.

8. The gearwheel of claim 7, wherein the microstructure is arranged at a radius of less than or equal to 50 mm around each recess.

9. The gearwheel of claim 7, wherein the microstructure is arranged at a radius of less than or equal to 30 mm around each recess.

10. The gearwheel of claim 7, wherein the microstructure is arranged at a radius of less than or equal to 20 mm around each recess.

11. A device comprising:
a gearwheel including a gearwheel side and a rear side opposite the gearwheel side, the rear side having a microstructure and one or more bores; and
a component including one or more further bores.

12. The device of claim 11, wherein the one or more bores and the one or more further bores are arranged in coaxial arrangement when the component and the gearwheel are connected together.

13. The device of claim 12, wherein the gearwheel and the component are connectable together for conjoint rotation by fastening means arranged in the one or more bores and one or more further bores.

14. The device of claim 11, wherein the device comprises a flange, the component is arranged between the flange and the gearwheel, and the flange includes one or more additional bores.

15. The device of claim 14, wherein the one or more bores, the one or more further bores, and the one or more additional bores. are arranged in a coaxial manner when the component and the gearwheel and the flange are connected together.

16. The device of claim 15, wherein the gearwheel and the component and the flange are connectable together for conjoint rotation by fastening means arranged in the one or more bores, one or more further bores, and one or more additional bores.

17. The device of claim 11, wherein the component comprises a differential housing.

18. A work machine comprising the device of claim 11.
